(19) United States
(12) Patent Application Publication
(10) Pub. No.: US 2012/0302703 A1
(43) Pub. Date: Nov. 29, 2012

(54) Method for Producing Metal-containing Nanoparticles Enveloped with Polymers and Particles that can be Obtained Therefrom

(75) Inventors: Andreas Greiner, Amoeneburg (DE); Seema Agarwal, Marburg (DE); Julia Schmidt, Worms (DE); Stefan Bokern, Bakum (DE)

(73) Assignee: Philipps-Universitaet Marburg, Marburg (DE)

(21) Appl. No.: 13/147,146

(22) PCT Filed: Feb. 1, 2010
(86) PCT No.: PCT/DE10/00095

§ 371 Date: Oct. 26, 2011

(30) Foreign Application Priority Data
Jan. 30, 2009 (DE) 10 2009 006 942.9
Feb. 26, 2009 (DE) 10 2009 010 421.6
Feb. 27, 2009 (DE) 10 2009 010 670.7

(51) Int. Cl. C08F 8/42; C08F 20/14; C08F 12/08; B82Y 99/00

(52) U.S. Cl. 525/330.4; 525/333.5; 977/773

(57) ABSTRACT

The present invention provides a method to produce metal-containing nanoparticles enveloped with polymers, as well as particles obtainable therefrom.

In the method according to the present invention, at least one anionic polymerizable monomer is polymerized in the presence of an anionic macroinitiator at room temperature. Subsequently, an aliphatic or aromatic sulfide is firstly added, followed by a solution of at least one organosoluble metal salt in an aprotic organic solvent and finally a homogeneous reducing agent. The metal cation is hereby reduced to the metal. Metal-containing nanoparticles are formed which are covalently bonded to the growing anionic polymerizates.

The metal salts are preferably salts of silver, copper, gold, tin, lead, chrome or zinc, or mixtures thereof. Anionic polymerizable monomers comprise, by way of example, styrene (St), butadiene, isoprene, ethylene oxide, propylene oxide, caprolactone, lactide, glycolide, acrylates, methacrylates, bisacrylates, cyanoacrylates, amides, siloxanes, vinylpyridines or acrylonitrile.

The particles according to the present invention are suitable to be used for the antibacterial finishing of polymers in textiles and materials. Furthermore, they are suitable for the production of inks. If the underlying metals are those metals that show plasmon resonance, the particles are suitable to also be applied in sensors which use the plasmon resonance effect.

The metal-containing nanoparticles enveloped with polymers which are accessible using the method according to the present invention do not aggregate or agglomerate, and their physical and chemical properties remain unchanged over a long period of time.

The present invention concerns the fields of polymer chemistry, metal processing and material sciences. It provides a method for producing metal-containing nanoparticles enveloped with polymers and particles that can be obtained therefrom.

### STATE OF THE ART

There are numerous technical applications for metal-containing nanoparticles enveloped with polymers. By way of example, they are used in the antibacterial finishing of polymers in textiles and materials. Furthermore, the plasmon resonance effect of some metals is used in sensors and thermally switchable windows. Such metal-containing nanoparticles are also used in inks.

As such, several possibilities for the antibacterial finishing of polymers are already known. A technically well-established method for the finishing of polymers is the incorporation of silver salts or silver nanoparticles into these polymers. The membranes of bacteria are destroyed due to the silver ions discharged as a result of this process.

However, the incompatibility of the polymers with the silver salts or silver nanoparticles is frequently problematic, which is why this often leads to mechanical defects, severe discoloration or turbidity of the polymers. The remedy for this is to envelope silver nanoparticles with polymers. There are various methods for doing this.

DE-A1-10 2006 058 202 describes a method for the production of an aqueous dispersion, comprising at least one polymer and/or oligomer and inorganic surface-modified particles. The inorganic particles are suitable to be metal oxides and are suitable to be surface-modified with anionic polymerizates. DE-A1-103 46 387 describes a germicidal, silver-comprising agent for the antimicrobial finishing of surfaces. The germicidal agent may optionally comprise one or more film-forming polymers, selected from the group comprising polyacrylates, polyvinyl alcohols, and polyvinyl acetals. The silver used is preferably nanosilver.

DE-A1-102 61 806 describes polymer-stabilized nanoparticles or nanostructured composite materials. The nanoparticles are suitable to be metals. However, only those metal-containing nanoparticles that are produced from barium salts are disclosed.

The metals silver, copper and gold do not only comprise antibacterial properties. They also show plasmon resonance, which is suitable to be excited via IR or UV-VIS radiation. The interaction between the plasmons in the case of Ag is hereby higher than with other metals, as described in David D. Evanoff Jr., George Chumanov, “Synthesis and Optical Properties of Silver Nanoparticles and Arrays” ChemPhysChem 2005, 6, 1221-1231. Plasmon resonance is understood to mean a collective oscillation of all the electrons in a nanoparticle. In the case of spherical particles, this occurs independently of the angle of incidence and the direction of the electric field vector (e-vector), referred to as the direction of polarisation. Silver is the only material which is suitable to cover the entire visual wavelength range from 400 to 800 nm via plasmon resonance, wherein the geometry of the particle (form and size) plays a decisive role.

The article by Evanoff et al. cited above describes a method for producing silver nanoparticles enveloped with polymers, wherein silver nanoparticles are provided; in the presence of these particles, polystyrene or PMMA is subsequently polymerized via emulsion polymerization. However, the method is only suitable to be used for a limited number of monomers and solvents, and for relatively large silver particles (approx. 100 nm in diameter). Furthermore, the particles produced aggregate quickly.

Furthermore, the state of the art comprises silver particles that are coated with a polymer or incorporated into this as an additive. This is how L Quaroni and G Chumanov describe silver nanoparticles that are enveloped with polystyrene or polymethacrylate in “Preparation of Polymer-Coated Functionalized Silver Nanoparticles”, J Am Chem Soc 1999, 121, 10642-10643. The coating process with polystyrene or polymethacrylate was achieved via emulsion polymerization, resulting in particles with sizes between 2 and 10 nm.

In D D Evanoff Jr, P Zimmermann, G Chumanov: “Synthesis of Metal-Teflon AF Nanocomposites by Solution-Phase Methods”, Adv Mater 2005, 17, 1905-1908, silver particles coated with teflon are described. A highly expensive fluorine-containing metal salt and teflon are dissolved in a perfluorinated solvent; this is subsequently reduced and then precipitated.

Polymer-stabilized gold nanoparticles are described in Muriel K. Corbierre, Neil S. Cameron, and R. Bruce Lennox: “Polymer-Stabilized Gold Nanoparticles with High Grafting Densities” Langmuir, 2004, 20, 2867-2873. The particles described are not antibacterial, comprise very large polydispersities, are relatively large, and have many deformations.

### Aim of the Invention

The aim of the invention is to overcome this disadvantage and other disadvantages of the state of the art and provide a new method for producing metal-containing nanoparticles enveloped with polymers. Furthermore, metal-containing nanoparticles enveloped with polymers which are obtainable via such a method are aimed at.

Achievement of this Aim

The present invention overcomes the disadvantages of the state of the art by providing a method with which metal-containing nanoparticles are suitable to be enveloped with polymers quickly and cost-effectively without the addition of stabilizers. In this way, metal-containing particles enveloped with polymers are obtainable, which comprise the antibacterial properties of the underlying metals or the plasmon resonance, respectively (in the case of silver, copper and gold), without comprising the hitherto known disadvantages of these particles, such as discolorations, turbidity and mechanical defects of polymers or uncontrollable particle sizes and the undesired propensity for aggregation.

The aim to provide a method to produce metal-containing nanoparticles enveloped with polymers is therefore achieved according to the present invention by means of a method comprising the steps:

a) production of a solution of an anionic macroinitiator in an aprotic organic solvent,

b) addition of at least one anionic polymerizable monomer to this solution,

c) anionic polymerization at room temperature,

d) addition of an aliphatic or aromatic sulfide,

e) addition of a solution comprising at least one organosoluble metal salt in an aprotic organic solvent,

f) addition of a homogeneous reducing agent in case the redox potential of the at least one organosoluble metal salt does not suffice in order for it to become exclusively reduced to the metal via aliphatic or aromatic sulfide,

g) precipitation of the produced particles with an organic solvent,

h) separation and drying of the particles.

Surprisingly, it was found that metal-containing nanoparticles are suitable to be covalently bonded to growing anionic polymerizates if an aliphatic or aromatic sulfide is added to the growing anionic chain end and then organosoluble metal salts are added. Metal-containing nanoparticles enveloped with polymers are hereby formed.

The method according to the present invention to produce metal-containing nanoparticles enveloped with polymers, as well as the metal-containing nanoparticles enveloped with polymers obtainable therefrom are described hereinafter, wherein the invention comprises individually and in combination with one another all the preferred embodiments presented hereinafter.

“Organosoluble metal salts” are understood to mean those salts that dissolve in organic solvents, particularly in aprotic organic solvents. A non-exhaustive list of examples comprises metal salts whose anion is selected from the group of acetates, trifluoroacetates, acetylacetonates, benzoates, iodides and/or a mixture thereof. Regarding the corresponding metal cations, a non-exhaustive list of examples comprises cations of silver, copper, gold, tin, lead, chrome, zinc and/or a mixture thereof.

If more than one organosoluble metal salt is used, two or more of these metal salts are suitable to comprise a common anion or a common cation.

In a preferred embodiment, these are organosoluble salts of antibacterially effective metals, for example salts of silver, copper, gold, tin, lead, chrome or zinc. Alternatively, this may involve metal alloys such as silver/gold alloys, silver/copper alloys or copper/gold alloys, or nanoparticles coated with an antibacterially effective metal, e.g. Cu nanoparticles with Ag coating, Fe nanoparticles with Cu coating, magnetite nanoparticles with Ag coating, or titanium dioxide nanoparticles with Ag coating.

It is known to persons skilled in the art how alloys nanoparticles are suitable to be produced. For that purpose, mixtures of salts of two different metals, for example, can be reduced simultaneously. The way in which coated nanoparticles of a first metal is suitable to be produced using a second metal is also known to a person skilled in the art. Persons skilled in the art are able to apply this knowledge without leaving the scope of protection of the patent claims.

In a further preferable embodiment, these are organosoluble salts of metals that show plasmon resonance, such as organosoluble silver, copper and gold salts.

The terms “macroinitiator” or just “initiator” are understood according to the present invention as substances that initiate an anionic polymerization. A non-exhaustive list of examples of this comprises alkali metal alcoholates, metal alkyls, amines, Grignard compounds (alkaline earth alkyls), Lewis bases and one-electron carriers (e.g. napthylsodium).

Particularly preferable are metal alkyls such as secondary butyllithium (s-BuLi).

The aprotic organic solvents are selected, by way of a non-exhaustive list of examples, from ethers (such as tetrahydrofuran (THF), diethyl ether), toluene, benzene, hexane, cyclohexane, heptane, octane, DMSO and mixtures thereof. In principle, every aprotic solvent is suitable that dissolves the anionically polymerizable monomor, the aliphatic sulfide or aromatic sulfide, the at least one organosoluble metal salt and the living polymer and does not react chemically with the monomer or the living polymer. With regard to the present invention, ‘dissolve’ means that the monomer, sulfide, metal salt or polymer, respectively, are soluble to at least 0.1 wt.-% in the solvent or solvent mixture.

A “living polymer” is hereby understood to mean a polymer chain that was not yet broken and is therefore still suitable to react further. For instance, it is known that styrene is suitable to be anionically polymerized and other monomers or more styrene are suitable to be attached to this ‘living’ polystyrene until the reaction is interrupted.

The same solvent or solvent mixture is preferably used for the solution of the anionic macroinitiator according to step a) as is the case for the solution of the at least one organosoluble metal salt according to step e).

A non-exhaustive list of anionic polymerizable monomers comprise styrene (St), butadiene, isoprene, ethylene oxide, propylene oxide, caprolactone, lactide, glycolide, acrylates, methacrylates, bisacrylates, cyanoacrylates, amides, siloxanes, vinylpyridines, and acrylonitrile. The anionic polimerizates obtainable from this are polystyrene, polybutadiene, polyisoprene, polyethylene oxide, polypropylene oxide, polycaprolactone, polyactide, polyglycolide, polyacrylates, polymethacrylates, polybisacrylates, polycyanoacrylates, polyamides, polysiloxanes, polyvinylpyridines, and polyacrylonitrile. The anionic polimerizates are suitable to be linear, branched, highly branched, radial or dendritic; furthermore, this is suitable to be statistical copolymers such as block and graft copolymers.

“At least one anionically polymerizable monomer” according to step b) of the method according to the present invention means that one or more anionically polymerizable monomers according to the above list are suitable to be used. If at least two of these anionically polymerizable monomers are used, statistical copolymers or block or graft copolymers according to the present invention are thus obtained. By way of example, copolymers are obtained by providing two similarly reactive monomers at the same time which are then incorporated into the particles being formed. Block copolymers are obtained by initially adding a monomer and then adding the second and, successively, other monomers. In a preferred embodiment, the anionic polymerizable monomer is selected from styrene and methacrylate.

By using sulfur-containing polymers, the nanoparticles can also be enveloped. A non-exhaustive list of polymers that are suitable to be used include polyamides such as polyamide 66, polyvinylamides, polyvinylamine, polyvinylacetate, polyvinyl alcohols, polyisoprene, polybutadiene, and copolymers with styrene or acrylnitrile for example, polychloroprene, ethylene propylene diene rubber, cross-linkable polyurethanes, silicones with thiol or sulfide groups, poly-alkylsulfides, polyalkyl sulfonic acids, polyalkylsulfonates, rubbers, or combinations of these polymers as copolymers, as well as block and graft polymers or polymer blends. Provided that the polymers do not comprise sulfur groups, sulfur groups are, by way of a non-exhaustive list of examples, inserted into these polymers via sulfur, sulfuric acid, disulfur dichloride, ethylenethiourea, mercaptanes, polyarylene sulfides or xanthogen sulfide and derivatives such as alkylxanthogen sulfides, xanthogen polysulfides or alkylxanthogen polysulfides. The polymers are cross-linked via vulcanization. The sulfur groups lead, on the one hand, to a cross-linking of the polymers and, on the other, cause stabilization of the metal-containing nanoparticles.

The advantage of this is that the production method for the cross-linked polymers is only slightly impaired, as only metal salts still have to be added.

Polymers or rubbers with metal inserts which comprise antistatic properties are suitable to be produced via the subsequent reduction of the metal salts.

The aliphatic or aromatic sulfide is, by way of example, an alkylsulfide such as ethylene sulfide or propylene sulfide, or an aromatic sulfide such as styrene sulfide. Ethylene sulfide is preferred.

The homogeneous reduction agent is, by way of a non-exhaustive list of examples, superhydride (lithium triethylborohydride) or hydrazine.

The aliphatic or aromatic sulfide according to step d) of the method according to the present invention acts as a reduction agent for the metal salt, as it is suitable to transfer electrons to the metal cation. It is known to persons skilled in the art that such a reduction is dependent on the redox potential of the metal in question. The so-called ‘standard potentials’ of metal/metal salt redox pairs can be consulted in the electrochemical series. By definition, standard potentials refer to standard conditions, which is to say at a temperature of 25° C., a pressure of 101.3 kPa, a pH value of 0 and an ion activity of 1. If a metal salt whose corresponding metal is more ignoble than hydrogen according to the electrochemical series is used in step e) of the method according to the present invention, a homogeneous reduction agent according to step f) therefore has to be added in order that the reduction takes place.

In the case of metal salts whose corresponding metal is more noble than hydrogen according to the electrochemical series, the reduction capacity of the sulfide added according to step d) of the method according to the present invention thereby suffices, in principle, to reduce metal cations to metal. However, it hereby has to be noted that silver cations, for example, only require one electron in order to be reduced to silver, while two electrons are necessary for the reduction of Cu²⁺-ions to elemental copper. For the same concentration of Cu²⁺- or Ag⁺-salt and sulfide, less Cu²⁺ is therefore reduced to Cu than Ag⁺ to Ag. It is known to persons skilled in the art that the amount of reducible metal salt depends, inter alia, on the concentration of the metal salt and the reduction agent, upon which the respective redox potential and the number of electrons that have to be transferred is dependent. If the solution of the at least one metal salt according to step e) of the method according to the present invention is a sufficiently diluted solution of the salt of a noble metal, it may be the case that due to the low salt concentration, the redox potential is not high enough for the reduction to the metal to take place. In this case, the addition of a homogeneous reduction agent according to step f) is required when using a salt of a noble metal.

In a preferred embodiment, the at least one organosoluble metal salt is a salt or salts from metals that are nobler than hydrogen, and a homogeneous reduction agent is added in step f) of the method according to the present invention.

The precipitation of the metal-containing nanoparticles enveloped with polymers produced using the method according to the present invention takes place using a precipitant such as water, methanol, ethanol, n-propanol, isopropanol, acetone, diethyl ether, methyl acetate, ethyl acetate, hydrocarbons such as pentane, hexane, heptane, cyclohexane, cycloheptane, and benzine, as well as mixtures of these solvents.

In a preferred embodiment, precipitation takes place using water, methanol or ethanol, which is suitable to be acidified beforehand or to which an acid salt such as calcium chloride is added.

The type of solution agent and precipitant required for each individual polymer is known to persons skilled in the art.

“Precipitant” hereby refers to that solvent or solvent mixture that is used for the precipitation of the metal-containing nanoparticles enveloped with polymers.

In the present invention, the precipitant is selected so that it dissolves with the solvent in which the macroinitiator and anionically polymerizable monomer were dissolved. Furthermore, the precipitant is chosen so that it does not dissolve the polymer produced during the reaction.

The method according to the present invention is suitable to be implemented in both a discontinuous (batch method) and continuous fashion, for example in a microreactor.

In the case of a discontinuous implementation of the method as a batch process, production takes place in a single reaction vessel, as described above.

In an advantageous embodiment, the macroinitiator and the sulfide are used at a ratio of 1:1 (equivalent/equivalent).

The macroinitiator and the at least one anionically polymerizable monomer are advantageously used at a ratio of initiator:monomer=1:10 to 1:100 (equivalent/equivalent).

In a preferred embodiment, the metal salt is the salt of a noble metal, and a reduction agent according to step f) of the method according to the present invention is not added. In this case, 2-3 equivalents of metal salt per equivalent of monomer are used; preferably 2.3 equivalents. Furthermore, as described above one equivalent of macroinitiator and one equivalent of sulfide are used per equivalent of monomer in this embodiment.

In a particularly preferred embodiment, respectively one equivalent of monomer, sulfide and macroinitiator and respectively 1 to 8 equivalents of metal salt and a homogeneous reduction agent are used, wherein as many equivalents of metal salt as of reduction agent are used.

In the case of continuous implementation of the method, for example in a microreactor, steps a) to d) according to the method above are prepared in a first vessel. The solution of the at least one organosoluble metal salt in an aprotic organic solvent is provided in a second vessel. These two solutions are then continuously merged, for example in a microreactor, and the product solution produced is continuously removed. The precipitation of the particles formed from the product solution according to step f) takes place in a third vessel. The precipitated particles according to step g) are then separated and dried.

The nanoparticles enveloped with polymers according to the present invention comprise a diameter of approximately 2 nm to 300 nm, wherein the dispersion around the mean amounts to 30% to 70%. The metal particles hereby have an inner diameter of approximately 1 nm to 10 nm, and the thickness of the polymer layer amounts to approximately 0.5 nm to 300 nm.

It should be emphasized that all metal-containing nanoparticles enveloped with polymers which are accessible using the method according to the present invention do not aggregate or agglomerate, and their physical and chemical properties are therefore maintained over a very long period of time. As such, the particles according to the present invention are, for example, UV stable, as they are suitable to be exposed for several months to sunlight without changing. The chemical stability was suitable to be shown, as the particles were exposed to semi-concentrated nitric acid without a change occurring within the particles.

The method according to the present invention allows the use of the entire spectrum of anionically polymerizable monomers. The particles produced are, inter alia, therefore so stable, because every polymer chain is individually and coordinatively bonded to the metal surface.

The metal-containing nanoparticles enveloped with polymers which are accessible using the method according to the present invention are suitable to be used as non-aggregating antibacterial substances. They are hereby suitable to be either directly processed or added as an additive to the antibacterial and/or antistatistic finishing of other polymers. As such, the nanoparticles are suitable to either be directly used or used as an additive in films or coatings, respectively, components (extrudates, pressed pieces), or fibers (macrofibers, microfibers, nanofibers, electrospun fibers). They are suitable to be used, by way of example, in antibacterial lacquers, antibacterial textiles, antibacterial filters, antibacterial membranes, and antibacterial components.

The metal-containing nanoparticles enveloped with polymers according to the present invention are likewise used as antistatic additives for the production of antistatic sheets, components, fibers, granulates or master batches.

The metal-containing nanoparticles stabilized with polymers are hereby suitable to be mixed together with a first polymer matrix. The mixture is suitable to be a powder, granulate, a liquid or a paste. This mixture with further additives and polymers is converted into granulate in an extruder. Through this, a mixture from silver nanoparticles with polystyrene was produced. This mixture was then extruded with further polystyrene. An equal distribution of silver nanoparticles was hereby achieved. For this reason, antibacterial and/or antifungal properties was suitable to be introduced into a granulate. The granulate likewise displays antistatic properties. The granulate is suitable to be further processed, by way of a non-exhaustive list of examples, into melt-spun fibers, melt-blown microfibers or sheets.

The metal-containing nanoparticles stabilized with polymers are also suitable to be used as viscous pastes with antibacterial and/or antifungal properties. These pastes, which also have antistatic properties, are suitable, for example, to be used in the construction industry.

The metal-containing nanoparticles stabilized with polymers are also suitable to be used as aprotic solutions with antibacterial and/or antifungal properties. As such, a solution of silver nanoparticles in toluene enveloped with polystyrene was suitable to be produced.

Furthermore, the metal-containing nanoparticles enveloped with polymers according to the present invention are suitable to be used for the production of inks. This is particularly advantageous if this concerns the metals gold, silver, copper or alloys thereof. Inkjet printing processes present an alternative to conventional photolithography in the production of electronic components. If the polymer(s) of the nanoparticles according to the present invention is (are) thermally degradable, these polymers are suitable to be optionally removed after printing, for example via pyrolysis. In this way, very thin metal lines are obtained. If the particles according to the present invention are silver particles, silver lines which are antibacterial, electrically conductive and thermally conductive are thereby suitable to be produced.

The inks are produced according to the present invention, so that the respective metal nanoparticles are produced from the corresponding metal salts via reduction in solution in the presence of a polymer that is provided with so-called ‘thiol groups’ on the chain ends. This hereby leads to the formation of metal nanoparticles which are chemically bonded to the thiol-terminated polymers. Through this, the metal nanoparticles are no longer able to aggregate. The metal nanoparticles are consequently suitable to be processed into powders by removing the solvent. The powders obtained from this is then suitable to be added to a solvent again for the production of inks, and therefore redispersed without aggregation occurring. Depending on the desired use, the inks are then suitable to be further individually adjusted by adding other substances, e.g. dyes or agents that modify viscosity.

A further use of the nanoparticles enveloped with polymers produced via the method according to the present invention (and whose outer metal is silver, copper or gold) is caused by its plasmon resonance.

The plasmon resonance effect is suitable to be used, by way of example, in immunosensors in kinetics and bioanalytics: the aforementioned gold, silver or copper nanoparticles enveloped with polymers according to the present invention are suitable to adsorb foreign molecules. Due to this change in the ligand shell, the plasmon resonance frequency of the particle changes. Very low concentrations of foreign molecules, such as biomolecules, are therefore suitable to be detected via plasmon resonance measurement.

Provided that they comprise a reversible thermochromic effect (which is caused by the modified interferences of plasmon resonances), the metal-containing nanoparticles enveloped with polymers are also suitable to be used in thermally switchable windows and sensor technology.

The use of nanoparticles enveloped with polymers produced by the method according to the present invention is suitable to occur in the form of powders, dispersions, pastes and solid bodies. The following application purposes are, inter alia, hereby conceivable: antibacterial and/or antistatic finishing of components, sheets or fibers, use as silent additives (for example in security inks), use in the production of electrical conductor paths, which may be of particular interest in the near-field electrospinning or inkjet printing sectors, use in the production of particular optical encodings—for example if barcodes with additional functions are desired. Furthermore, the nanoparticles enveloped with polymers produced according to the present invention would be suitable to be used in the production of metal alloys. The high miscibility of the nanoparticles enveloped with polymers would be particularly advantageous. The production of composites with glass is also conceivable for the same reason.

### FIGURE LEGENDS

FIG. 1

FIG. 1 shows TEM images (transmission electron microscopy) from silver nanoparticles that were produced according to practical embodiment 1. In FIG. 1a), particles are shown after stirring in an ultrasonic bath, while in FIG. 1b), particles are shown after stirring with a magnetic stirrer.

While the silver cores that were produced via magnetic stirrer are 5 nm large (FIG. 1b) and exist individually, there are those produced in the ultrasonic bath that agglomerate into structures of 200 nm in size (FIG. 1a).

FIG. 1a): The bar in the bottom right-hand corner of the figure corresponds to 2.6 μm.

FIG. 1b): The bar in the bottom right-hand corner of the figure corresponds to 2 nm.

FIG. 2

The structure of the core shell particles was examined via AFM, wherein particles with the molecular weight of the oligostyrene shell of 326 g/mol were used for this method of analysis.

The structure of the core-shell particles postulated is suitable to be substantiated on the basis of FIG. 2. The AFM images were taken at varying magnifications:

FIG. 2a): Magnification Ag/St=0.1; M=326 g/mol

FIG. 2b): Magnification Ag/St=4.35; M=326 g/mol.

St=Styrene; M=326 g/mol refers to the molecular weight of the oligostyrene shell. From the low magnification one recognizes that all particles are identically structured and each has a core (silver) and a shell (styrene chain).

FIG. 3

This shows the antibacterial effect of films from industrial polystyrene (Mₙ=100,000) and core-shell silver nanoparticles according the embodiment 2.

FIG. 3a) shows the antibacterial effect on E. coli.

FIG. 3b) shows the antibacterial effect on M. luteus.

B₂ indicates a blend from the above-mentioned industrial polystyrene and core-shell silver nanoparticles with a molecular weight of the shell polymer of 326 g/mol. The weight ratio of the blend is 12 to 88.

B₄ indicates a blend from the above-mentioned industrial polystyrene and core-shell silver nanoparticles with a molecular weight of the shell polymer of 1980 g/mol. The weight ratio of the blend is 11 to 89.

B₆ indicates a blend from the above-mentioned industrial polystyrene and core-shell silver nanoparticles with a molecular weight of the shell polymer of 116590 g/mol. The weight ratio of the blend is 14 to 86.

FIG. 4

FIG. 4 shows an SEM image of the polystyrene film with core-shell nanoparticles according to embodiment 2.

The white bar in the bottom right-hand corner of the image corresponds to 600 nm.

FIG. 5

TEM image of silver nanoparticles with polystyrene shells synthesized via microreaction.

FIG. 5 shows an overview of several polymer drops on the edge of a grid hole. The silver particles are faintly recognizable in the drops.

The scale bar in the upper right-hand corner of the image corresponds to 100 nm.

FIG. 6

TEM image of silver nanoparticles with polystyrene shells synthesized via microreaction.

FIG. 6 shows a single polymer drop with several silver particles. The scale bar in the upper right-hand corner of the image corresponds to 5 nm.

FIG. 7

TEM image of silver nanoparticles with polystyrene shells synthesized via microreaction.

FIG. 7 shows a single silver particle with recognizable lattice planes. The scale bar in the lower left-hand corner of the image corresponds to 1 nm.

FIG. 8

TEM image of silver particles with polystyrene or polymethacrylate shells, respectively. The scale bar in the upper right-hand corner of the image corresponds to 50 nm.

FIG. 9

UV-Vis spectrum of A: non-coated and B: silver particles coated with polystyrene in water (solid line) or 1.8 M NaCl solution (dotted line).

FIG. 10

TEM image of silver particles in teflon. The scale bar in the lower right-hand corner of the image corresponds to 30 nm.

FIG. 11

Palladium nanoparticles, synthesized with thiol-end-functionalized polystyrene, with a molecular weight Mₙ=2600 g/mol and a molar ratio of polystyrene to palladium acetate of 1:1, produced according to embodiment 6.

FIG. 12

Transmission electron microscopy image of the palladium nanoparticles produced according to embodiment 6 in the polystyrene matrix following extrusion and hot pressing.

FIG. 13

Palladium nanoworms, synthesized with thiol-end-functionalized polystyrene with a molecular weight Mₙ=2600 g/mol and a molar ratio of polystyrene to palladium acetate of 1:3.

FIG. 14

High resolution TEM image of the nanoworms shown in FIG. 13 with edges of the structure subsequently marked. The crystalline area at the end of the structure can be clearly recognized.

FIG. 15

Powder x-ray diffraction patterns of the palladium nanoworms (W) shown in FIG. 13 and FIG. 14 and the spherical palladium nanoparticles (S) from FIG. 11. At 2-theta=20°, the amorphous halo of polystyrene can be recognized. At 2-theta=40°, the reflex of palladium expanded by the nanostructuring can clearly be recognized. The only difference is in the intensity of the signal. This shows that the worm-like structures from FIG. 13 and FIG. 14 are pure palladium.

FIG. 16

Polystyrene film after extrusion and hot pressing at 150° C. with a thickness of 0.5 cm and a Pd nanoparticle concentration of 0.01 percent by weight. The width of the image is approximately 10 cm.

### PRACTICAL EMBODIMENTS

### Practical embodiment 1

Production of Silver Nanoparticles Enveloped with Polystyrene

The mixing of the reaction solution was guaranteed using a magnetic stirrer or ultrasonic bath, respectively. 10 ml THF with initiator (sBuLi/cyclohexane 1.3 M) was provided in a flask. The reaction temperature was 25° C. Polymerization was started by quickly adding the monomer (St). The solution immediately turned dark red. After complete polymerization (approximately 5 min), ethyl sulfide THF solution was added to the mixture. The color disappeared after several seconds. A solution of silver trifluoroacetate in THF was then added and the reaction mixture was stirred for 10 min. The particles formed from this were precipitated from methanol. After the precipitated samples were removed by filtration, they were dried in the vacuum furnace at 60° C. for 20 h.

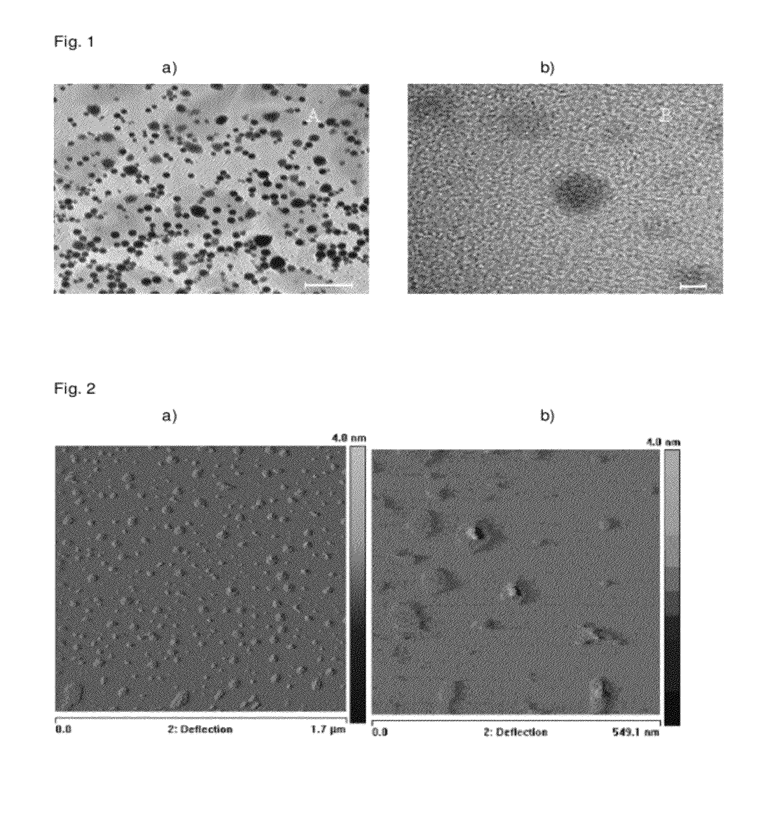

The size of the particles was clarified via TEM (transmission electron microscopy) or AFM (atomic force microscope). The particle sizes were between 3 and 200 nm, depending on silver content and production method. The TEM images of the particles are shown in FIG. 1. The structure of the core-shell particles was examined via AFM. This is shown in FIG. 2.

### Practical Embodiment 2

### Antibacterial Effect of the Core-Shell Particles

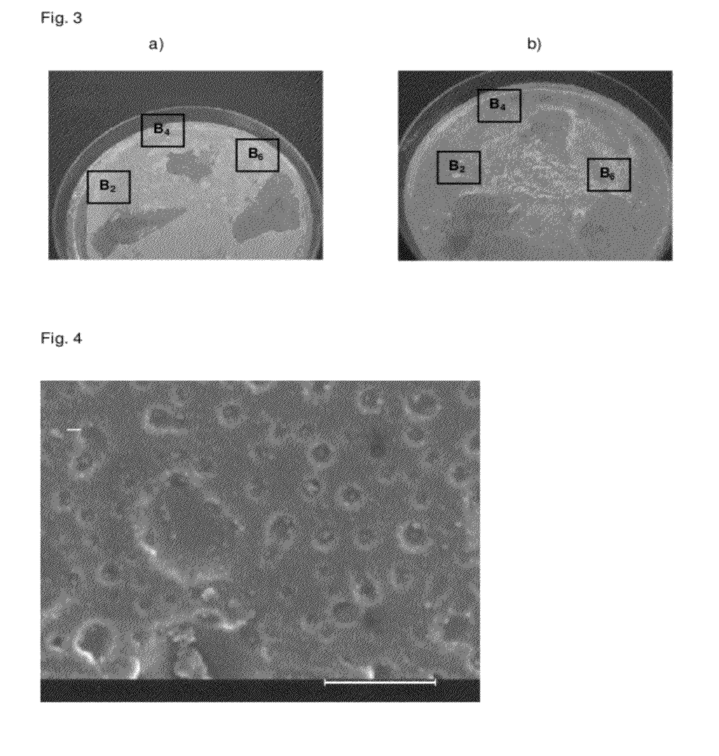

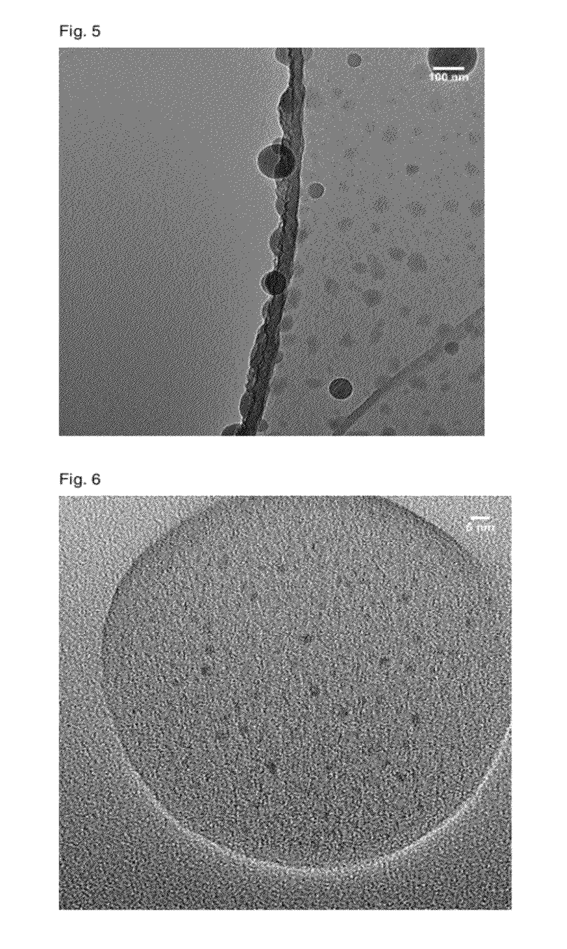

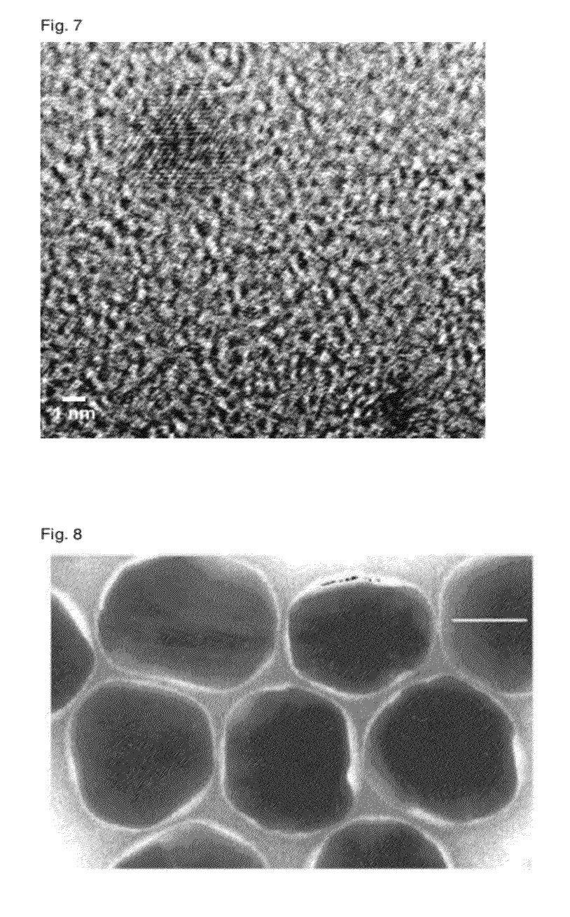

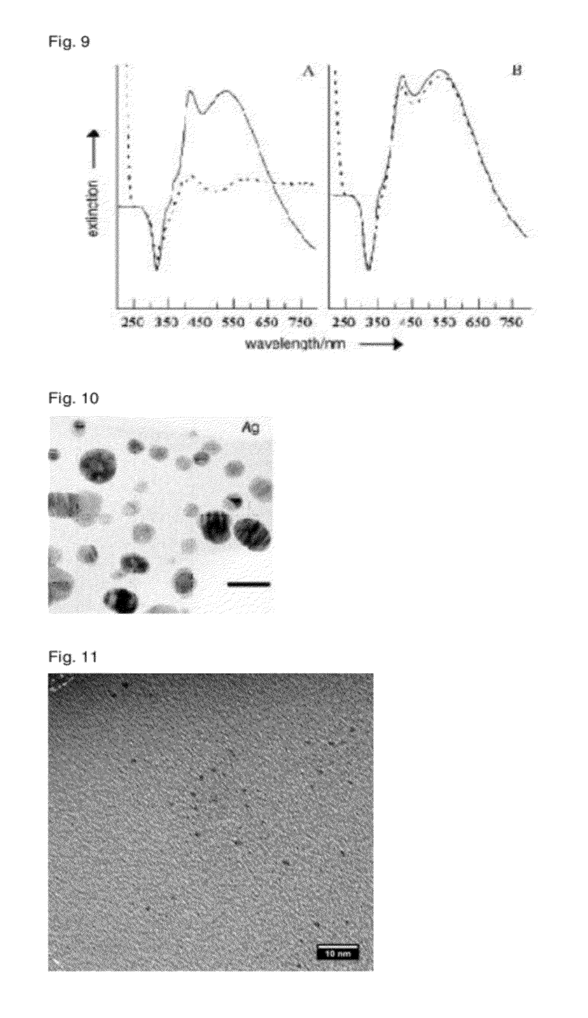

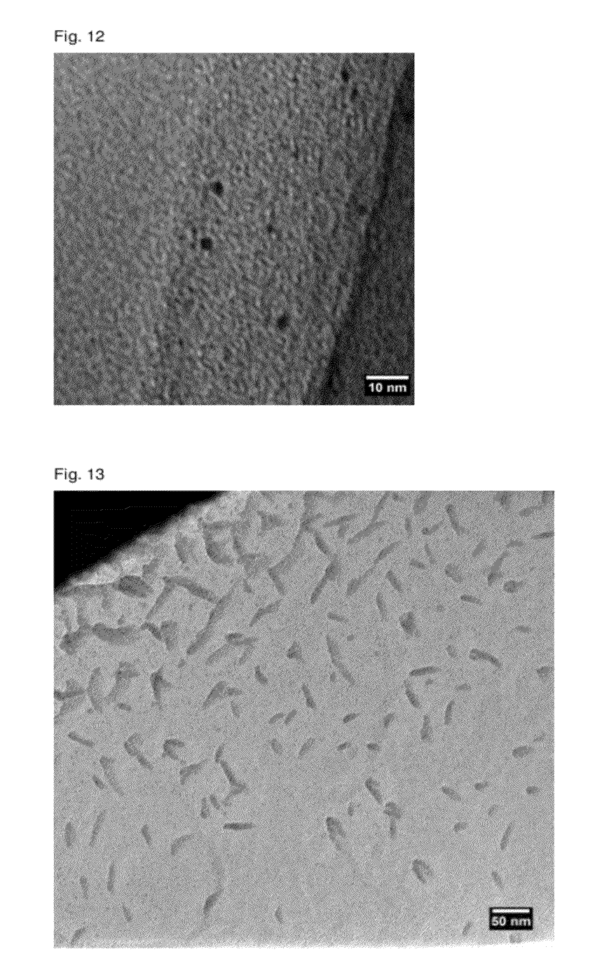

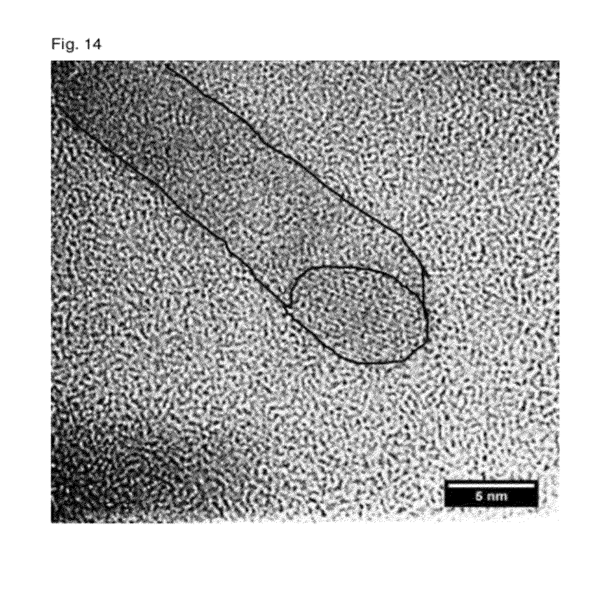

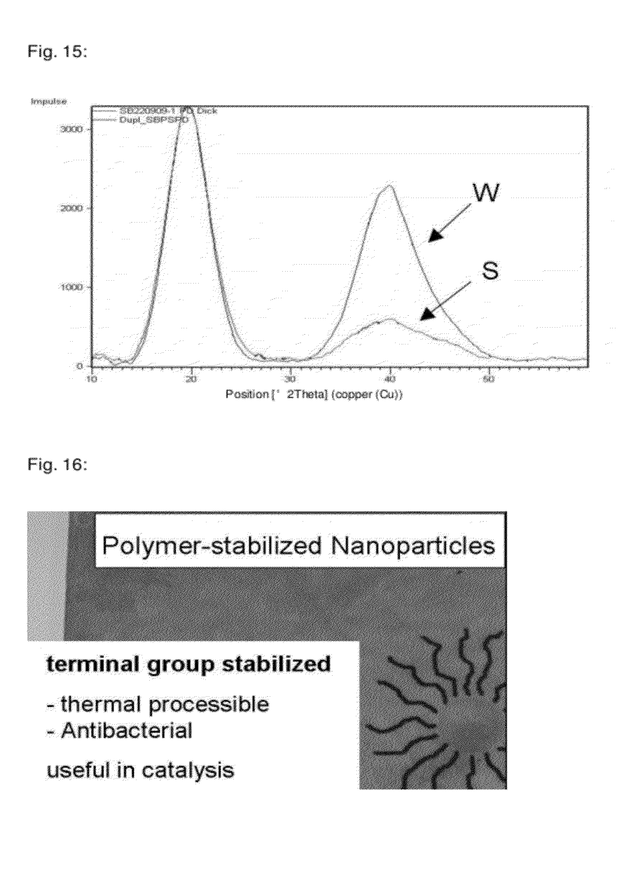

Due to the composition of the core-shell particles (silver core), an antibacterial effect was expected. For this reason, films from industrial polystyrene (Mₙ=100,000) and the particles were prepared: A solution was produced from industrial PS (Mₙ=100,000) and core-shell nanoparticles in THF. This solution was used to pour out the bottom of a petri dish or to apply it with a squeegee as a film on a glass plate, respectively, and left for 20 h in order to dry out the solvent. The film was removed and used for further examinations. The antibacterial effect of the polymer films was examined for E. coli (Escherichia coli) and M. luteus (Micrococcus luteus). It could be established that the films function antibacterially due to the discharge of silver ions. However, its concentration was not sufficient to inhibit the growth of M. luteus completely. This is shown in FIG. 3.

The polystyrene shell around the silver core impeded the discharge of silver ions due to the strong hydrophobic properties. The fact that they are emitted at all relates to the structure of the film surface. The core-shell particles are on the surface of the film (FIG. 4) despite the low concentration, facilitating the interaction with water, thereby making the antibacterial effect possible.

### Practical Embodiment 3

Synthesis of Silver Nanoparticles Coated with Polystyrene Via Micro Reaction Device

### a) Synthesis of the Macroinitiator

A 25 mL nitrogen flask preheated in a vacuum is filled with 10 mL cyclohexane (distilled over calcium hydride) and 6.5 mL butyllithium (1.3 mol/L in cyclohexane, 8.5 mmol) under argon and warmed to 40° C. under stirring. 2 mL styrene (distilled over calcium hydride, 17 mmol) is quickly added. The solution immediately turns dark red. The solution is stirred for another 10 minutes at 40° C. and stored at −20° C. until use.

### b) Synthesis of the Thiolate-Functionalized Polystyrene

A 1 liter nitrogen flask preheated in a vacuum is filled with 400 mL THF (dried over potassium hydroxide, distilled over phosphorous pentoxide) under argon. Under stirring at 25° C., so much macroinitiator solution is added that the red color remains unchanged; a further 26 mL (11.9 mmol) of macroinitiator is subsequently added. 15.5 mL styrene (135 mmol) is quickly added; the dark red solution is stirred for another 10 minutes at 25° C. 0.71 mL ethylene sulfide (12 mmol) is added to the solution which subsequently takes on a pale yellow color. The solution is stored at −20° C. until use.

### c) Production of the Silver Trifluoroacetate Solution

3.06 g silver trifluoroacetate (11.9 mmol) is dissolved in 446 mL THF_{abs} under argon. The solution is protected with aluminum foil from incident light and stored at −20° C.

d) Arrangement of the Micro Reaction Device

Two syringe pumps (Sykam S1610, pump head made of teflon, inner volume of the glass syringes 10 mL respectively) are connected via stainless steel tubes to a pressure sensor and a microreactor (Ehrfeld LH25, mixing plate 50/50 μm, aperture plate 50 μm). The exit of the microreactor is connected with a stainless steel tube (length approx. 2 meters, inner volume 1.92 mL).

### e) Realization of the Synthesis Via Microreaction

First, both syringe pumps are flushed with 500 mL water, 500 mL THF, 150 mL cyclohexane and 300 mL THF_{abs} respectively, to remove any type of impurity. Pump 1 is flushed with 180 mL of the solution of the functionalized polymer (solution 1), pump 2 is flushed with 180 mL of the silver trifluoroacetate solution (solution 2). The pumps are set to the respective pumping speed and switched on. 5 mL of the product solution is discarded and 40 mL of the product solution is collected in a vessel. The product is precipitated in 400 mL methanol, aged for 2 hours, removed by filtration and dried overnight in the vacuum furnace at 60° C.

Example for pumping speeds reaction mix SB160508-2:

polystyrene solution (solution 1): 10.00 mL/minute
silver trifluoroacetate solution (solution 2): 13.20 mL/minute
For other assays, the pumping speeds are varied as required.

FIG. 5 to FIG. 7 show TEM images of silver particles with polystyrene shells synthesized via microreaction.

### Practical Embodiment 4

Preparation of Poly(Styrene-Block-Co-MMA)-Ag with a Magnetic Stirrer

20 mL THF was warmed to 25° C. in the water bath. The macroinitiator solution (c=0.5 mol/L) newly synthesized according to 3.a) was added to THF until the red color of the macroinitiator was stable. A further 0.65 mL macroinitiator (c=0.50 mol/L, 0.33 mmol, 1.00 eq.) was subsequently added to the solution. 3.01 g styrene (3.4 mL, 28.9 mmol, 87.58 eq.) was quickly added to the solution. After five minutes, 90.1 mg 1,1-diphenlyethylene (0.50 mmol, 1.5 eq.) was added to the dark red solution. After another five minutes, 460.6 mg methylmethacrylate (0.49 mL, 4.60 mmol, 13.94 eq.) was added to solution. After another five minutes, 50.0 mg ethylene sulfide (0.84 mmol, 2.48 eq.) was added to solution. 10 mL silver trifluoroacetate solution (c=34.9 mmol/L, 0.349 mmol, 1.06 eq. in THF) was added to the solution. After five minutes, the solution was inserted into a tenfold excess of methanol. The brown precipitate was removed by filtration, washed with water and methanol, and dried for 12-16 h in the vacuum furnace at 60° C.

The particles obtained were examined by means of transmission electron microscopy. For that purpose, a JEM 3010 instrument of the company JEOL was used. The measurements were taken with a LaB6 crystal as a cathode at a voltage of 300 kV. The preparation of the samples took place on 300 mesh copper grids with graphite coating by immersing them in a strongly diluted chloroform dispersion of the nanoparticles and drying them with air.

The evaluation took place with the instrument's own Gatan Digital Microscope program and the program ImageJ, version 1.40g from the National Institute of Health, USA. Diameters from 100 to 150 particles were measured per sample. The average diameter and the standard deviation were determined using the program OriginPro, version 7.5.

Average diameter of the particles according to practical embodiment 4: 4.3 nm

Standard deviation: 1.5 nm (35%).

### Practical Embodiment 5

### Copper Nanoparticles Enveloped Polystyrene

A solution of thiolate-functionalized polystyrene was prepared as described above (reaction mix 150508-2, Mₙ=4400 g/mol, c=11.1 mmol/L). 71 mg copper(II)acetylacetonate (0.27 mmol, 2.47 eq.) in 10 mL THF was added to 10 mL of this solution (0.11 mmol, 1.00 eq.). 1 mL hydrazine solution (c=1 mol/L in THF, 1 mmol, 9.35 eq.) was added to the solution. The white precipitate formed was removed by filtration and discarded. The solution was inserted into a tenfold excess of methanol. The colorless product was removed by filtration, washed with water and methanol, and dried overnight in the vacuum furnace at 60° C.

Yield: 263 mg (52%)

The particles according to practical embodiment 5 were examined by means of transmission electron microscopy as described under embodiment 4.

Average diameter of the particles according to practical embodiment 5: 2.2 nm

Standard deviation: 0.6 nm (27%)

The invention is not limited to one of the previously described embodiments; rather, it is suitable for being modified in all kinds of ways. One recognizes, however, that the present invention provides a method to produce metal-containing nanoparticles enveloped with polymers, as well as particles obtainable therefrom.

In the method according to the present invention, at least one anionic polymerizable monomer is polymerized in the presence of one anionic macroinitiator at room temperature. Subsequently, an aliphatic or aromatic sulfide is firstly added, followed by a solution of at least one organosoluble metal salt in an aprotic organic solvent, and finally a homogenous reducing agent. The metal cation is hereby reduced to the metal. Metal-containing nanoparticles are formed which are covalently bonded to the growing anionic polymerizates.

The metal salts are preferably salts of silver, copper, gold, tin, lead, chrome or zinc or mixtures thereof. Anionic polymerizable monomers comprise, by way of example, styrene (St), butadiene, isoprene, ethylene oxide, propylene oxide, caprolactone, lactide, glycolide, acrylates, methacrylates, bisacrylates, cyanoacrylates, amides, siloxanes, vinylpyridines, or acrylonitrile.

The particles according to the present invention are suitable to be used for the antibacterial finishing of polymers in textiles and materials. Furthermore, they are suitable for the production of inks. If the underlying metals are those which show plasmon resonance, the particles are suitable to also be applied in sensors which use the plasmon resonance effect.

The metal-containing nanoparticles enveloped with polymers which are accessible using the method according to the present invention do not aggregate or agglomerate, and their physical and chemical properties remain unchanged over a long period of time.

### Practical Embodiment 6

### Synthesis of Ultrasmall Palladium Nanoparticles in a Polystyrene Matrix

Thiolate-end-functionalized polystyrene in THF (Mₙ=4900 g/mol, 46 mmol/L, 0.15 mmol) is added to a solution of palladium(II)acetate (100 mg, 0.45 mmol) under stirring. After 5 minutes, a solution of triethylborohydride (1 mol/L in THF, 3 mL, 3 mmol) is added. After 20 minutes, the brown product is precipitated in methanol and washed and dried in a vacuum. Yield: 98%

TEM: spherical nanoparticles with an average diameter of 1.6 nm.

Repetition of the synthesis with short-chain thiolate-end-functionalized polystyrene (Mₙ=2600 g/mol) and 0.15 mmol palladium(II)acetate also provided spherical nanoparticles with an average diameter of 1.6 nm. Furthermore, the material was characterized with gel permeation chromatography, x-ray powder diffractometry and UV/Vis spectroscopy. The palladium nanoparticles shown in FIG. 11 are formed.

### Practical Embodiment 7

Coextrusion of Polystyrene-Stabilized Palladium Nanoparticles with Polystyrene

Coextrusion of polystyrene at 195° C. with industrial polystyrene (Mₙ=100,000 g/mol, BASF) as shown in FIG. 1 yielded a transparent, brown-colored material typical for palladium nanoparticles (final concentration of palladium at this juncture was 0.01 percent by weight), with a homogeneous distribution of palladium nanoparticles.

### Practical Embodiment 8

### Synthesis of Novel Structures Using Palladium Nanoworms as an Example

Thiolate-end-functionalized polystyrene in THF (Mₙ=2600 g/mol, 46 mmol/L, 0.15 mmol) is added to a solution of palladium(II)acetate (100 mg, 0.45 mmol) under stirring. After 5 minutes, a solution of triethylborohydride (1 mol/L in THF, 3 mL, 3 mmol) is added. After 20 minutes, the brown product is precipitated in methanol, washed and dried in a vacuum. Yield: 96%.

Worm-like nanoscale structures from palladium were obtained, as shown in FIG. 13.

All of the characteristics and advantages originating from the claims, the description and the figure, including constructive details, spatial arrangements and steps of the method, are suitable to be essential for the invention, both in themselves and in the most diverse combinations.

1. Method to produce metal-containing nanoparticles enveloped with polymers, comprising:
producing a solution of an anionic macroinitiator in an aprotic organic solvent,
adding at least one anionic polymerizable monomer to this solution,
carrying out anionic polymerization at room temperature,
adding an aliphatic or aromatic sulfide,
adding a solution comprising at least one organosoluble metal salt in an aprotic organic solvent, whereby particles are formed,
adding a homogeneous reducing agent if the redox potential of the at least one organosoluble metal salt is insufficient for the organosoluble metal salt to become exclusively reduced to the metal via the aliphatic or aromatic sulfide,
precipitating the formed particles with an organic solvent,
separating and drying the particles.

2. Method according to claim 1, wherein the at least one organosoluble metal salt is a salt of a metal selected from the group consisting of silver, copper, gold, tin, lead, chrome, zinc, palladium and mixtures thereof.

3. Method according to claim 1, wherein the at least one organosoluble metal salt is selected from the group consisting of acetates, trifluoroacetates, acetylacetonates, benzoates, iodides, and mixtures thereof.

4. Method according to claim 1, wherein the anionic macroinitiator is selected from the group consisting of alkali metal alcoholates, metal alkyls, amines, Grignard compounds (alkaline earth alkyls), and Lewis bases.

5. Method according to claim 1, wherein the anionic polymerizable monomer is styrene or methacrylate.

6. Method according to claim 1, wherein the aliphatic or aromatic sulfide is selected from the group consisting of ethylene sulfide, propylene sulfide, and styrene oxide.

7. Method according to claim 1, wherein the polymers comprise sulfur-containing groups.

8. Method according to claim 7, wherein cross-linking of polymers and stabilization of the metal nanoparticles occurs simultaneously.

9. Metal-containing nanoparticles enveloped with polymers obtained by the method of claim 1.

10. Antibacterial or antistatic finishings comprising metal-containing nanoparticles enveloped with polymers according to claim 9.

11. A plasmon resonance measurement method of ink production method comprising using metal-containing nanoparticles enveloped with polymers according to claim 9.

12. A master batch or granulate comprising metal-containing nanoparticles enveloped with polymers according to claim 9.
